(19) United States
(12) Patent Application Publication
(10) Pub. No.: US 2015/0373957 A1
(43) Pub. Date: Dec. 31, 2015

(54) Bubbling Fishing Lure

(71) Applicant: Gerald Joseph Smith, SR., Bellevue, NE (US)

(72) Inventor: Gerald Joseph Smith, SR., Bellevue, NE (US)

(21) Appl. No.: 14/623,391

(22) Filed: Feb. 16, 2015

Related U.S. Application Data
(60) Provisional application No. 62/017,129, filed on Jun. 25, 2014.

(51) Int. Cl. A01K 85/01; A01K 85/00

(52) U.S. Cl. CPC A01K 85/01; A01K 85/00

(57) ABSTRACT

A bubbling fishing lure is a device that produces bubbles upon coming into contact with water, attracting nearby fish. The device features a vessel that holds a replaceable at least one effervescent pill that produces bubbles upon coming into contact with water. The bubbles are able to escape from the vessel through a first set of bubble-releasing holes, providing auditory and visual stimulation to the fish. The device may be inserted into or attached to an existing fishing lure. Various embodiments of the device may include an adhesive, a ripple-inducing hinge, a dissolvable coating, a plurality of dissolvable plugs, and a second set of bubble-releasing holes. The device may also include an at least one quantity of scent-emitting attractant material in order to provide olfactory stimulation to fish in addition to auditory and visual stimulation.

The current application claims a priority to the U.S. Provisional Patent application Ser. No. 62/017,129 filed on Jun. 25, 2014.

### FIELD OF THE INVENTION

The present invention relates generally to a fishing lure. More specifically, the present invention is a bubbling fishing lure that is attached to an existing fishing lure and produces bubbles upon coming into contact with water. A fish is able to see, smell, and hear the bubbles, causing the fish to react and strike at the bubbling fishing lure, putting the bubbling fishing lure and existing fishing lure into its mouth.

### BACKGROUND OF THE INVENTION

When fishing for sport or recreation, it is common for a fisherman to utilize one or more fishing lures as bait in order to entice fish to strike and become caught on a hook. In addition to live bait such as earthworms and bait fish, artificial fishing lures are frequently utilized as well. A wide variety of fishing lures are available including surface lures that float on the surface of the water and plastic baits that resemble various insects, fish, and other creatures. Fishing lures are typically attached to a fishing line along with one or more hooks that are able to impale and catch a fish. A fishing lure is often designed to appeal to the fish's senses, causing the fish to strike at the fishing lure. After the fish has bitten into the fishing lure, the fisherman may then perform a hookset and secure the hook to the fish's mouth. Artificial fishing lures provide a number of benefits including reusability, ability to visually stimulate fish, and resemblance to a variety of live creatures that elicit a response in fish.

The present invention is a bubbling fishing lure that is utilized in conjunction with an existing fishing lure. The present invention is able to provide visual, olfactory, and auditory stimulation to a fish, causing the fish to strike at the fishing lure. The user is then able to perform a hookset and secure the hook to the fish's mouth. The present invention is attached to a fishing lure and is able to generate bubbles upon coming into contact with water after the user has cast off a line. The present invention is available in a number of embodiments including embodiments in which the present invention provides olfactory stimulation, auditory stimulation, or any combination of visual, olfactory, and auditory stimulation. The present invention is additionally available in a number of varying physical designs that allow the present invention to be utilized with various types of fishing lures.

### BRIEF DESCRIPTION OF THE DRAWINGS

FIG. 1 is a perspective view of the preferred embodiment of the present invention.

FIG. 2 is an exploded perspective view of the preferred embodiment of the present invention.

FIG. 3 is an additional exploded perspective view of the preferred embodiment of the present invention.

FIG. 4 is a front view of a first alternative embodiment of the present invention.

FIG. 5 is a cross-sectional view of the first alternative embodiment of the present invention taken along line A-A of FIG. 4.

FIG. 6 is a perspective view of a second alternative embodiment of the present invention.

FIG. 7 is a perspective view of the second alternative embodiment of the present invention in an open position.

FIG. 8 is a front view of a third alternative embodiment of the present invention.

FIG. 9 is a cross-sectional view of the third alternative embodiment of the present invention taken along line B-B of FIG. 8.

FIG. 10 is an exploded perspective view of a fourth alternative embodiment of the present invention.

FIG. 11 is a front view of the fourth alternative embodiment of the present invention.

FIG. 12 is a cross-sectional view of the fourth alternative embodiment of the present invention taken along line C-C of FIG. 11.

FIG. 13 is a front view of a fifth alternative embodiment of the present invention.

FIG. 14 is a cross-sectional view of the fifth alternative embodiment of the present invention taken along line D-D of FIG. 13.

FIG. 15 is a diagram of the at least one effervescent pill with the compositionally integrated at least one quantity of scent-emitting attractant material.

FIG. 16 is a perspective view of the present invention mounted into a fishing lure.

FIG. 17 is an exploded view of the present invention and a fishing lure.

FIG. 18 is a perspective view of the present invention attached directly to a fishing lure.

FIG. 19 is a perspective view of the present invention mounted to a fishing lure by a holder.

### DETAIL DESCRIPTIONS OF THE INVENTION

All illustrations of the drawings are for the purpose of describing selected versions of the present invention and are not intended to limit the scope of the present invention.

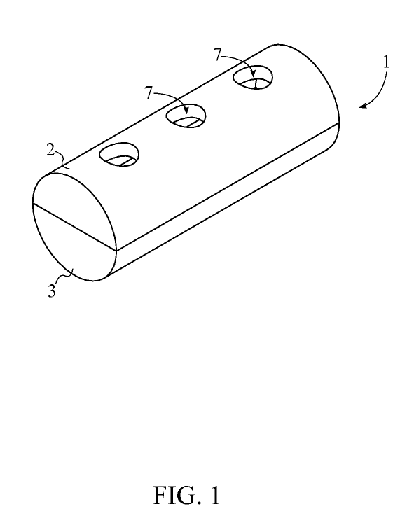

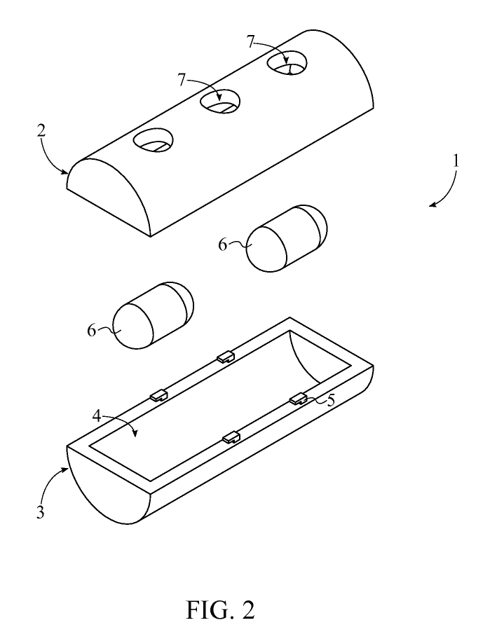

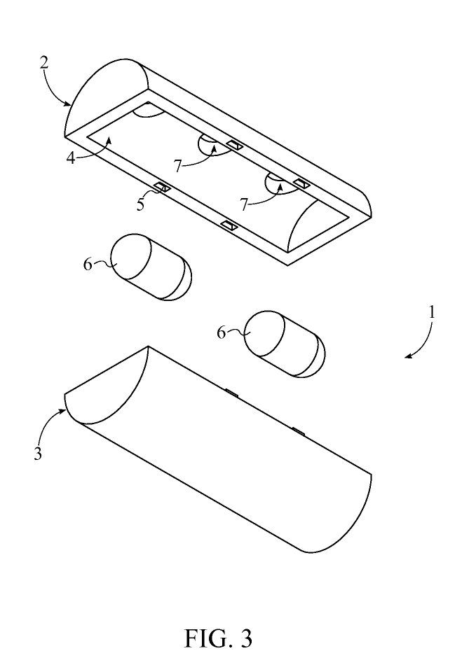

The present invention is a bubbling fishing lure that produces bubbles upon coming into contact with water in order to attract nearby fish. The preferred embodiment of the present invention is shown in FIGS. 1-3 and comprises a vessel 1, an at least one effervescent pill 6, and a first set of bubble-releasing holes 7. The vessel 1 is designed to house the at least one effervescent pill 6 and may be mounted into or attached to an existing fishing lure, a fishing line, or a fishing hook. The at least one effervescent pill 6 is able to produce bubbles via a chemical reaction upon coming into contact with water. The first set of bubble-releasing holes 7 allows the produced bubbles to escape from the interior of the vessel 1 and into the surrounding water.

The vessel 1 comprises a first open-ended container 2 and a second open-ended container 3. The first open-ended container 2 and the second open-ended container 3 are joined together in order to enclose the at least one effervescent pill 6 within the vessel 1. Conversely, the first open-ended container 2 and the second open-ended container 3 are separated in order to replace the at least one effervescent pill 6 after use. The first open-ended container 2 and the second open-ended container 3 each comprise an opening 4 and a clamping rim 5. The opening 4 provides a space for accommodating the at least one effervescent pill 6 when the at least one effervescent pill 6 is contained within the vessel 1. The clamping rim 5 allows the user to lock the first open-ended container 2 and the second open-ended container 3 together in order to prevent the second open-ended container 3 from separating from the first open-ended container 2 and vice versa. The mechanism of the clamping rim 5 may vary across various embodiments of the present invention. The clamping rim 5 is positioned around the opening 4 in order to ensure that the first open-ended container 2 and the second open-ended container 3 are securely joined together at the clamping rim 5. The clamping rim 5 of the first open-ended container 2 is removably attached to the clamping rim 5 of the second open-ended container 3. As such, the user is able to separate the first open-ended container 2 and the second open-ended container 3 in order to access the opening 4 of the first open-ended container 2 and the opening 4 of the second open-ended container 3. This allows the user to easily replace the at least one effervescent pill 6 after use of the present invention when fishing. The present invention is not limited with respect to the specific shape, size, or design of the vessel 1.

The first set of bubble-releasing holes 7 traverses into the first open-ended container 2, allowing bubbles produced by the at least one effervescent pill 6 upon exposure to water to escape from the interior of the vessel 1 through the first set of bubble-releasing holes 7 into the surrounding water. The first set of bubble-releasing holes 7 is distributed about the first open-ended container 2 in order to allow the produced bubbles to escape from the vessel 1 at multiple points. The at least one effervescent pill 6 is located within the vessel 1, preventing the at least one effervescent pill 6 from separating from the vessel 1 and to allow the at least one effervescent pill 6 to produce bubbles from within the interior of the vessel 1.

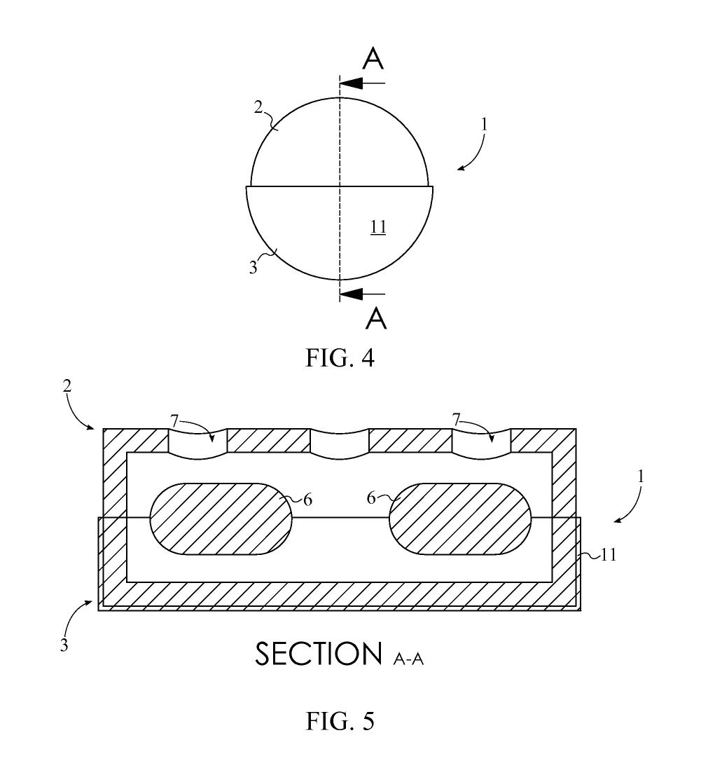

In the first alternative embodiment of the present invention shown in FIG. 4 and FIG. 5, the present invention further comprises an adhesive 11. The adhesive 11 is utilized to attach the present invention directly to an existing fishing lure. The adhesive 11 is externally layered onto the second open-ended container 3 in order to allow the second open-ended container 3 to be mounted to the fishing lure. This ensures that the first set of bubble-releasing holes 7 is not covered and that bubbles are able to escape from the vessel 1.

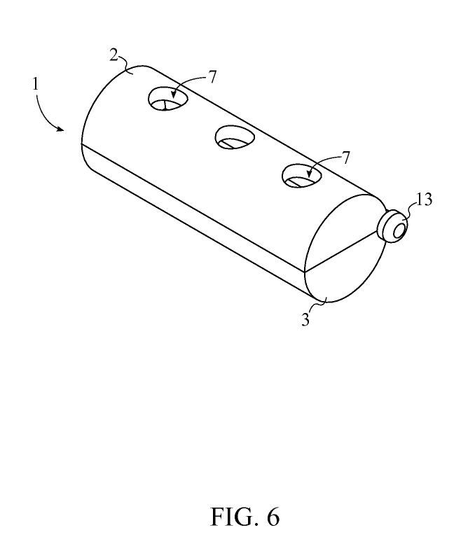

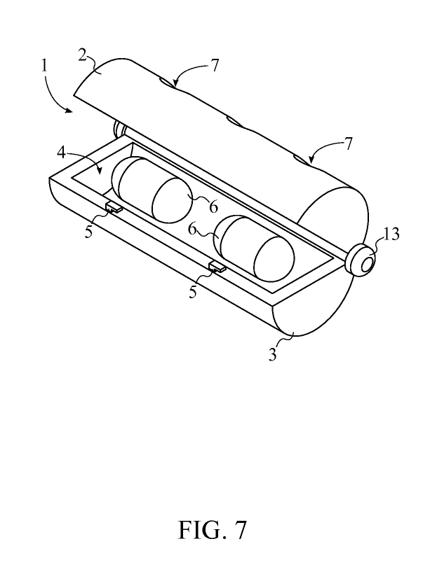

A second alternative embodiment of the present invention is shown in FIG. 6 and FIG. 7. The second alternative embodiment of the present invention further comprises a ripple-inducing hinge 13. The ripple-inducing hinge 13 is utilized to join the first open-ended container 2 to the second open-ended container 3. As such, the first open-ended container 2 and the second open-ended container 3 are hingedly connected by the ripple-inducing hinge 13. As shown in FIG. 7, this allows the user to open the vessel 1 via the hinge in order to replace the at least one effervescent pill 6 after use. The ripple-inducing hinge 13 additionally exerts a ripple effect when the present invention is moving through water that resembles the ripples formed by a fish's gills as the fish travels through the water. The ripple-inducing hinge 13 is externally positioned to the vessel 1 in order to allow the ripple-inducing hinge 13 to protrude outward from the vessel 1 and produce a ripple effect.

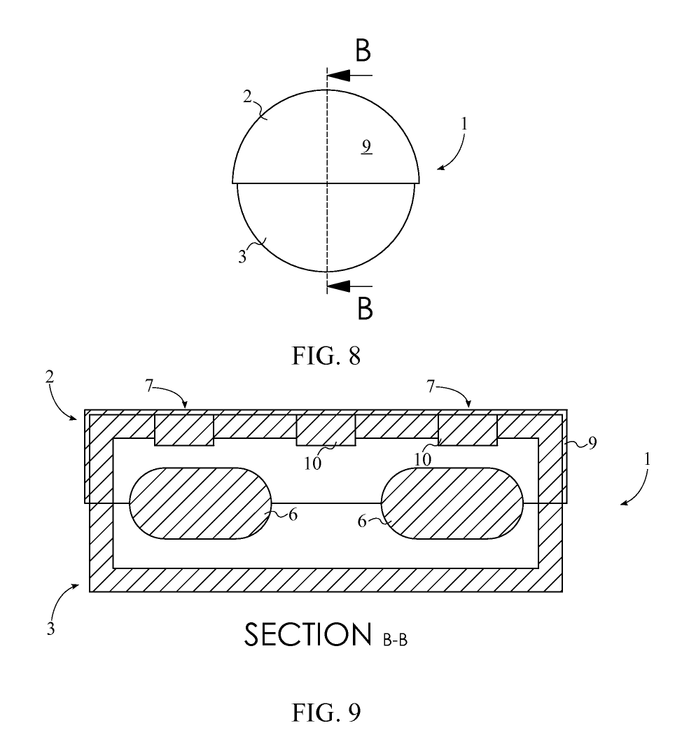

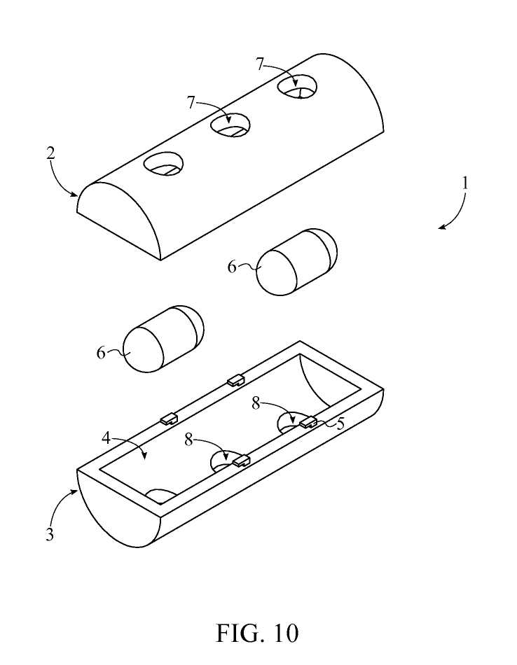

A third alternative embodiment of the present invention is shown in FIG. 8 and FIG. 9. This embodiment of the present invention comprises a dissolvable coating 9 as well as a plurality of dissolvable plugs 10. As shown in FIG. 9, each of the plurality of dissolvable plugs 10 is positioned within a corresponding hole from the first set of bubble-releasing holes 7. As such, each hole from the first set of bubble-releasing holes 7 is temporarily sealed when the present invention comes into contact with water. The dissolvable coating 9 is externally layered onto the first open-ended container 2 and the plurality of dissolvable plugs 10. As such, in the third alternative embodiment, the dissolvable coating 9 provides a further layer of coating for the first open-ended container 2, the plurality of dissolvable plugs 10, and the first set of bubble-releasing holes 7.

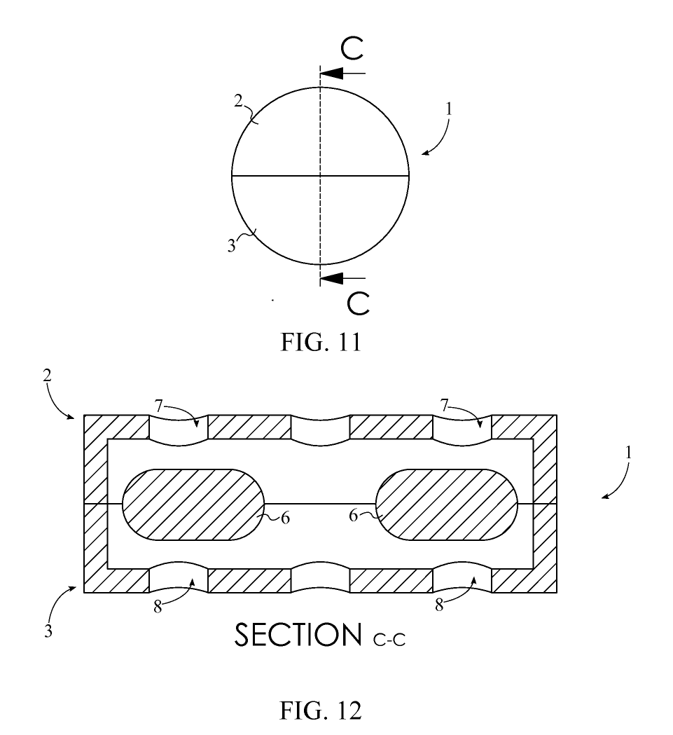

A fourth alternative embodiment of the present invention is shown in FIGS. 10-12. In FIGS. 10-12, the fourth alternative embodiment of the present invention comprises a second set of bubble-releasing holes 8. Similar to the first set of bubble-releasing holes 7, the second set of bubble-releasing holes 8 provides additional points of escape for the bubbles produced by the at least one effervescent pill 6. The second set of bubble-releasing holes 8 traverses into the second open-ended container 3, allowing bubbles to escape from within the vessel 1 to the surrounding water. Additionally, the second set of bubble-releasing holes 8 is distributed about the second open-ended container 3, providing multiple additional points of escape for the produced bubbles.

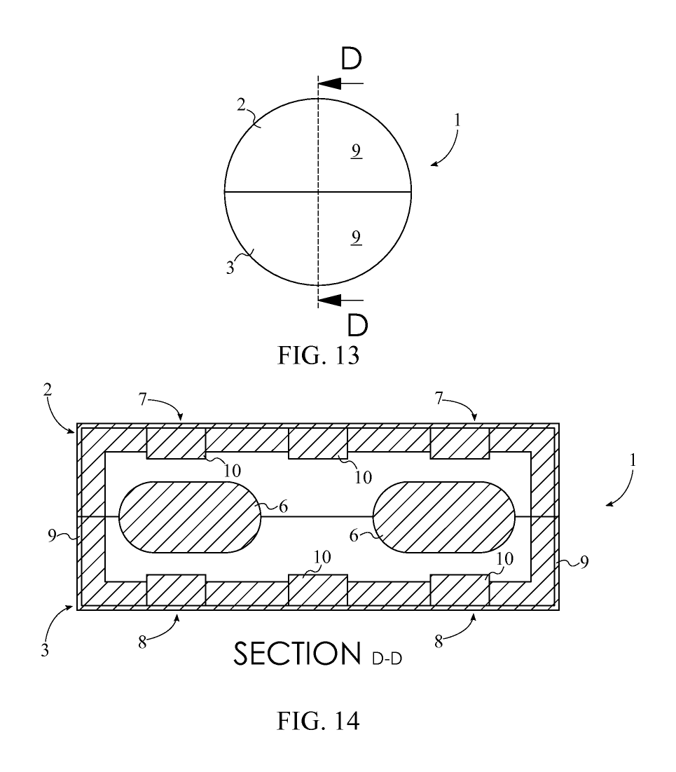

In the fifth alternative embodiment of the present invention shown in FIG. 13 and FIG. 14, the dissolvable coating 9 and the plurality of dissolvable plugs 10 allow for the delayed release of bubbles from the at least one effervescent pill 6 upon the present invention coming into contact with water. The dissolvable coating 9 provides a further layer of coating for the present invention in addition to the plurality of dissolvable plugs 10. Each of the plurality of dissolvable plugs 10 is positioned within a corresponding hole from the second set of bubble-releasing holes 8. This temporarily seals each hole from the second set of bubble-releasing holes 8 when the present invention first comes into contact with water. The plurality of dissolvable plugs 10 is able to dissolve a period of time after the present invention comes into contact with water, allowing water to enter the vessel 1 and come into contact with the at least one effervescent pill 6 and initiate the production of bubbles. The dissolvable coating 9 is externally layered onto the second open-ended container 3 and the plurality of dissolvable plugs 10. In the fifth alternative embodiment of the present invention, the dissolvable coating 9 is layered onto the second open-ended container 3 as well as the plurality of dissolvable plugs 10 positioned within the second set of bubble-releasing holes 8. Additionally, the dissolvable coating 9 is layered onto the first open-ended container 2 and the first set of bubble-releasing holes 7.

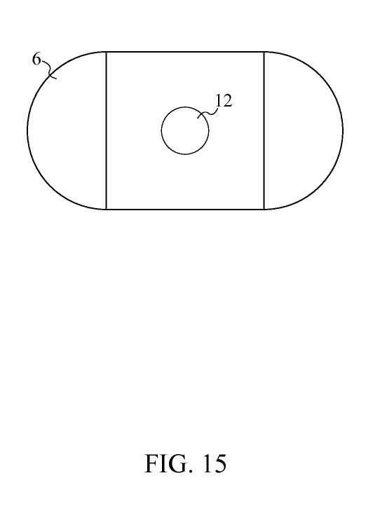

The present invention further comprises an at least one quantity of scent-emitting attractant material 12. The at least one quantity of scent-emitting attractant material 12 provides an olfactory effect for fish in addition to the auditory and visual effect provided by the at least one effervescent pill 6. The at least one quantity of scent-emitting attractant material 12 is compositionally integrated into the at least one effervescent pill 6 as shown in FIG. 15. This allows the auditory, visual, and olfactory effects of the present invention to be integrated into the at least one effervescent pill 6.

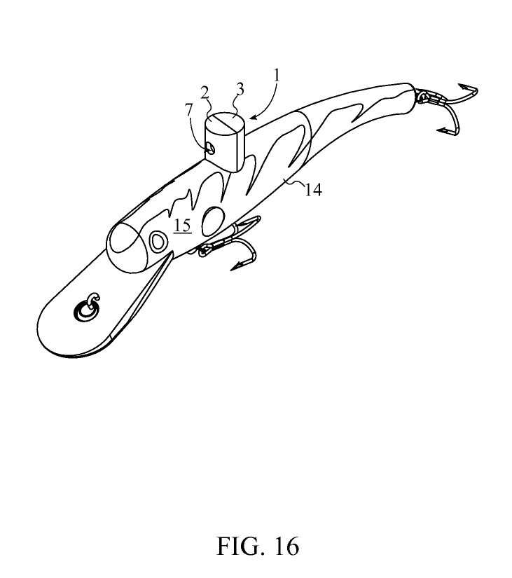

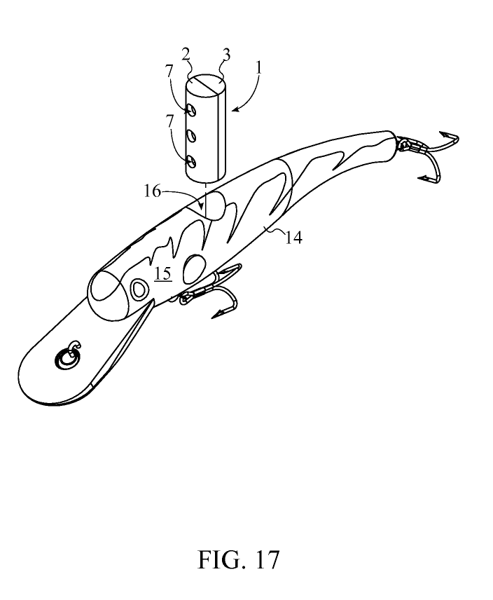

The present invention may be utilized in conjunction with an existing fishing lure 14. As shown in FIG. 16 and FIG. 17, the fishing lure 14 comprises an outer surface 15 and an at least one vessel-receiving cavity 16. The outer surface 15 is the exterior surface of the fishing lure 14 that is visible to the user. The at least one vessel-receiving cavity 16 is able to hold the vessel 1 in place within the fishing lure 14, allowing bubbles to be produced by the at least one effervescent pill 6 within the vessel 1 and provide the illusion of the bubbles being produced by the fishing lure 14. The at least one vessel-receiving cavity 16 traverses into the fishing lure 14 from the outer surface 15 in order to at least partially contain the vessel 1 within the fishing lure 14. The vessel 1 is removably mounted within the at least one vessel-receiving cavity 16 in order to allow the user to insert or remove the vessel 1 into and from the at least one vessel-receiving cavity 16 as shown in FIG. 17. The at least one vessel-receiving cavity 16 may be located anywhere on the fishing lure 14.

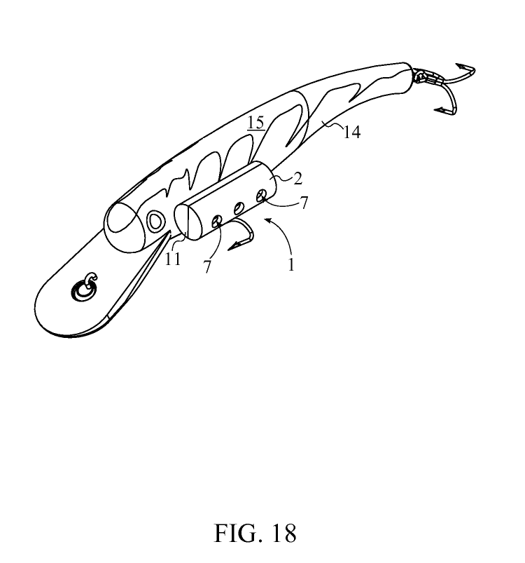

In addition to inserting the present invention into the fishing lure 14, the present invention may be directly secured to the fishing lure 14 as shown in FIG. 18. The present invention is integrated into the outer surface 15 in order to attach the present invention to the outer surface 15 of the fishing lure 14 rather than within the fishing lure 14. This is particularly useful if the user does not wish to drill into an existing lure in order to form the at least one vessel-receiving cavity 16.

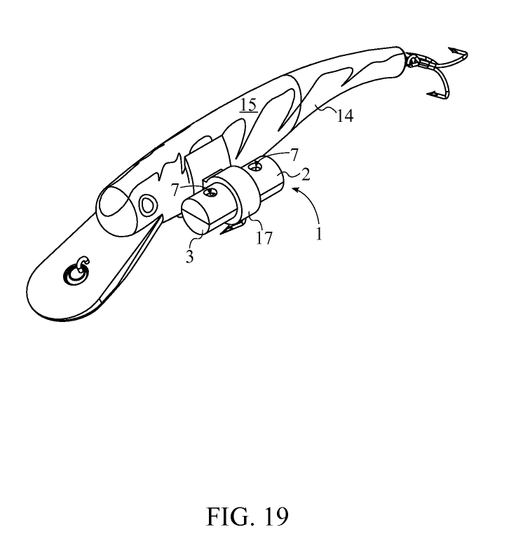

The present invention may additionally be secured to the fishing lure 14 with a holder 17. As shown in FIG. 19, the vessel 1 is externally mounted to the outer surface 15 by the holder 17, allowing the vessel 1 to be positioned close to the fishing lure 14 rather than within the fishing lure 14. Additionally, the vessel 1 is positioned offset from the outer surface 15 in order to provide a measure of distance between the fishing lure 14 and the vessel 1.

In addition to the fishing lure 14 shown in FIGS. 16-19 and similar crankbait, the present invention may additionally be utilized by securing the vessel 1 directly to a fishing line or a fishing hook. The first set of bubble-releasing holes 7 and the second set of bubble-releasing holes 8 may be utilized to secure the vessel 1 to a fishing line or fishing hook.

Although the present invention has been explained in relation to its preferred embodiment, it is understood that many other possible modifications and variations can be made without departing from the spirit and scope of the present invention as hereinafter claimed.

What is claimed is:

1. A bubbling fishing lure comprises:
a vessel;
an at least one effervescent pill;
a first set of bubble-releasing holes;
the vessel comprises a first open-ended container and a second open-ended container;
the first open-ended container and the second open-ended container each comprise an opening and a clamping rim;
the clamping rim being positioned around the opening;
the clamping rim of the first open-ended container being removably attached to the clamping rim of the second open-ended container;
the first set of bubble-releasing holes traversing into the first open-ended container;
the first set of bubble-releasing holes being distributed about the first open-ended container; and
the at least one effervescent pill being located within the vessel.

2. The bubbling fishing lure as claimed in claim 1 further comprises:
an adhesive; and
the adhesive being externally layered onto the second open-ended container.

3. The bubbling fishing lure as claimed in claim 1 further comprises:
a ripple-inducing hinge;
the first open-ended container and the second open-ended container being hingedly connected by the ripple-inducing hinge; and
the ripple-inducing hinge being externally positioned to the vessel.

4. The bubbling fishing lure as claimed in claim 1 further comprises:
a dissolvable coating;
a plurality of dissolvable plugs;
each of the plurality of dissolvable plugs being positioned within a corresponding hole from the first set of bubble-releasing holes; and
the dissolvable coating being externally layered onto the first open-ended container and the plurality of dissolvable plugs.

5. The bubbling fishing lure as claimed in claim 1 further comprises:
a second set of bubble-releasing holes;
the second set of bubble-releasing holes traversing into the second open-ended container; and
the second set of bubble-releasing holes being distributed about the second open-ended container.

6. The bubbling fishing lure as claimed in claim 2 further comprises:
a dissolvable coating;
a plurality of dissolvable plugs;
each of the plurality of dissolvable plugs being positioned within a corresponding hole from the second set of bubble-releasing holes; and
the dissolvable coating being externally layered onto the second open-ended container and the plurality of dissolvable plugs.

7. The bubbling fishing lure as claimed in claim 1 further comprises:
an at least one quantity of scent-emitting attractant material; and
the at least one quantity of scent-emitting attractant material being compositionally integrated into the at least one effervescent pill.

8. The bubbling fishing lure as claimed in claim 1 further comprises:
a fishing lure;
the fishing lure comprises an outer surface and an at least one vessel-receiving cavity;
the at least one vessel-receiving cavity traversing into the fishing lure from the outer surface; and
the vessel being removably mounted within the at least one vessel-receiving cavity.

9. The bubbling fishing lure as claimed in claim 1 further comprises:
a fishing lure;
the fishing lure comprises an outer surface; and
the second open-ended container being integrated into the outer surface.

10. The bubbling fishing lure as claimed in claim 1 further comprises:
a fishing lure;
a holder;
the fishing lure comprises an outer surface;
the vessel being positioned offset from the outer surface; and
the vessel being externally mounted to the outer surface by the holder.

11. A bubbling fishing lure comprises:
a vessel;
an at least one effervescent pill;
a first set of bubble-releasing holes;
an at least one quantity of scent-emitting attractant material;
a ripple-inducing hinge;
the vessel comprises a first open-ended container and a second open-ended container;
the first open-ended container and the second open-ended container each comprise an opening and a clamping rim;
the clamping rim being positioned around the opening;
the clamping rim of the first open-ended container being removably attached to the clamping rim of the second open-ended container;
the first set of bubble-releasing holes traversing into the first open-ended container;
the first set of bubble-releasing holes being distributed about the first open-ended container;
the at least one effervescent pill being located within the vessel;
the at least one quantity of scent-emitting attractant material being compositionally integrated into the at least one effervescent pill;
the first open-ended container and the second open-ended container being hingedly connected by the ripple-inducing hinge; and
the ripple-inducing hinge being externally positioned to the vessel.

12. The bubbling fishing lure as claimed in claim 11 further comprises:
an adhesive; and
the adhesive being externally layered onto the second open-ended container.

13. The bubbling fishing lure as claimed in claim 11 further comprises:
a dissolvable coating;
a plurality of dissolvable plugs;
each of the plurality of dissolvable plugs being positioned within a corresponding hole from the first set of bubble-releasing holes; and
the dissolvable coating being externally layered onto the first open-ended container and the plurality of dissolvable plugs.

14. The bubbling fishing lure as claimed in claim 11 further comprises:
a second set of bubble-releasing holes;
the second set of bubble-releasing holes traversing into the second open-ended container; and
the second set of bubble-releasing holes being distributed about the second open-ended container.

15. The bubbling fishing lure as claimed in claim 12 further comprises:
a dissolvable coating;
a plurality of dissolvable plugs;
each of the plurality of dissolvable plugs being positioned within a corresponding hole from the second set of bubble-releasing holes; and
the dissolvable coating being externally layered onto the second open-ended container and the plurality of dissolvable plugs.

16. The bubbling fishing lure as claimed in claim 11 further comprises:
a fishing lure;
the fishing lure comprises an outer surface and an at least one vessel-receiving cavity;
the at least one vessel-receiving cavity traversing into the fishing lure from the outer surface; and
the vessel being removably mounted within the at least one vessel-receiving cavity.

17. The bubbling fishing lure as claimed in claim 11 further comprises:
a fishing lure;
the fishing lure comprises an outer surface; and
the second open-ended container being integrated into the outer surface.

18. The bubbling fishing lure as claimed in claim 11 further comprises:
a fishing lure;
a holder;
the fishing lure comprises an outer surface;
the vessel being positioned offset from the outer surface; and
the vessel being externally mounted to the outer surface by the holder.
